(19) United States
(12) Patent Application Publication
(10) Pub. No.: US 2006/0228922 A1
(43) Pub. Date: Oct. 12, 2006

(54) Flexible PCB connector

(76) Inventor: Jeff C. Morriss, Cornelius, OR (US)

Correspondence Address: BUCKLEY, MASCHOFF, TALWALKAR LLC, 5 ELM STREET, NEW CANAAN, CT, 06840, US

(21) Appl. No.: 11/093,669

(22) Filed: Mar. 30, 2005

(51) Int. Cl. H01R 29/00

(52) U.S. Cl. 439/171

(57) ABSTRACT

According to some embodiments, an electrical connector may comprise a first flexible printed circuit board comprising a first electrical contact area, and an elastic biasing element to bias the first electrical contact area in at least one direction. In some embodiments, the electrical connector may further include a second printed circuit board, comprising a second electrical contact area, wherein the elastic biasing element is to bias the first electrical contact area toward the second electrical contact area to form a substantially coplanar electrical connection between the first and second electrical contact areas.

### BACKGROUND

It is desirable to transmit electrical signals within and between electrical devices (such as computers and telecommunications devices) at increasingly faster rates. In particular, multi-Gigabit per second (i.e., multi-GHz) signaling rates may greatly increase the functionality of electrical devices and networks. The signal integrity requirements for multi-Gigabit per second signaling, however, require minimal crosstalk, reflections, and losses from impedance discontinuities. While effort has been directed to reducing loss and crosstalk due to Printed Circuit Board (PCB) characteristics, other elements of transmission channels (such as connectors, sockets, and Integrated Circuit (IC) packages) may have become the limiting factors in channel performance.

Typical connectors, for example, utilize pins or surface mounting locations that carry electrical signals and perform mechanical functions necessary to maintain an electrical connection. Some connectors are able to maintain the mechanical integrity of an electrical connection despite dimensional tolerance variations and vibrations by utilizing a mechanical spring action. The mechanical spring action however, typically requires a structure that is electrically long compared to the wavelength of the spectral content of multi-Gigabit per second signals. As a result, conventional connectors may be mechanically unsuitable and/or may not provide the signal integrity required for a given application.

### BRIEF DESCRIPTION OF THE DRAWINGS

FIG. 1 is a perspective diagram of a system according to some embodiments.

FIG. 2 is a plan view of a system according to some embodiments.

FIG. 3 is a side view of a system according to some embodiments.

FIG. 4A is a cut-away side view of a system according to some embodiments.

FIG. 4B is a cut-away side view of a system according to some embodiments.

FIG. 5A is a side view of a system according to some embodiments.

FIG. 5B is a cut-away side view of a system according to some embodiments.

FIG. 6 is a block diagram of a system according to some embodiments.

### DETAILED DESCRIPTION

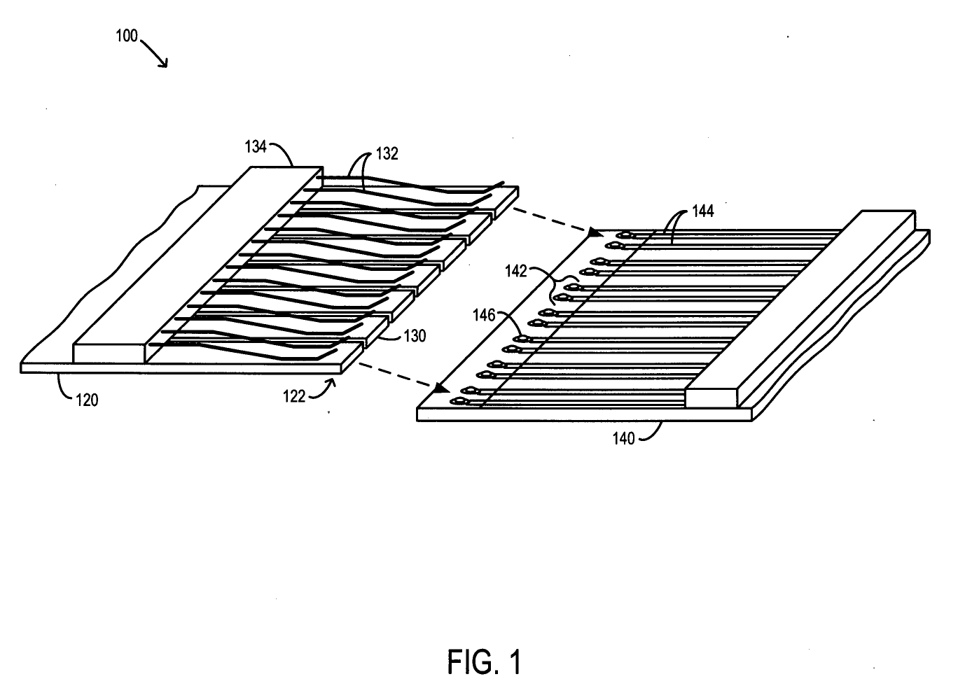

Referring first to FIG. 1, a perspective diagram of a system 100 according to some embodiments is shown. The system 100 may, according to some embodiments, comprise a first Printed Circuit Board (PCB) 120 that may further comprise one or more electrical contact areas 122. In some embodiments, the first PCB 120 may also or alternatively comprise one or more pliant portions 130, one or more elastic biasing elements 132, and/or a retention mechanism 134. According to some embodiments, the system 100 may also or alternatively comprise a second PCB 140 that may further comprise one or more electrical contact areas 142, one or more electrical traces 144, and/or one or more electrical contact surfaces 146. In some embodiments, the system 100 may include fewer or more components than are shown in FIG. 1. The various systems described herein are depicted for use in explanation, but not limitation, of described embodiments. Different types, layouts, quantities, and configurations of any of the systems described herein may be used without deviating from the scope of some embodiments.

According to some embodiments, the system 100 may be or include a connector. The system 100 may, for example, be or include the internal components of an electrical connector. In some embodiments, the system 100 may also or alternatively comprise a connector housing and/or body (not shown in FIG. 1). The system 100 may, according to some embodiments, comprise an electrical connector that is capable of passing electrical signals with such substantial signal integrity that multi-Gigabit per second signaling rates may be utilized in the system 100. The mating of the two connector halves (e.g., the first PCB 120 and the second PCB 140) may, for example, form a substantially coplanar connection that does not require mechanical elements (e.g., the elastic biasing elements 132) to be included within the electrical signal path. In such a manner, for example, impedance discontinuities in the signal channel may be substantially reduced.

In some embodiments, the first PCB 120 and/or the second PCB 140 may be constructed of flexible PCB material. The first PCB 120 may, for example, be a flexible PCB that is capable of being deflected by an elastic biasing element 132. According to some embodiments, the elastic biasing element 132 may bias the electrical contact area (and/or areas) 122 of the first PCB 120 toward the electrical contact area (and/or areas) 142 of the second PCB 140. In some embodiments, the first PCB 120 may comprise one or more pliant portions 130. The pliant portion 130 may, for example, be a portion of the first flexible PCB 120 that is substantially more pliant than the first PCB 120 (which may itself be flexible). As shown in FIG. 1, for example, the pliant portion 130 may be a finger-like portion of the first flexible PCB 120 that is defined by a channel, groove, cut, and/or other discontinuity in the flexible material of the first PCB 120.

In some embodiments (such as shown in FIG. 1), the first PCB 120 may comprise and/or define a plurality of pliant portions 130. Each pliant portion 130 may, according to some embodiments, be biased in at least one direction (e.g., toward the second PCB 140) by one of the plurality of elastic biasing elements 132. The elastic biasing elements 132 may, for example, comprise one or more springs and/or spring-like elements. In some embodiments, the elastic biasing elements 132 may be retained by the retention mechanism 134. The retention mechanism 134 may be or include any mechanism capable of coupling to at least one end and/or surface of the elastic biasing elements 132 that is or becomes known or practicable. In some embodiments, each pliant portion 130 may be acted upon by at least one elastic biasing element 132.

According to some embodiments, the first PCB 120 may comprise an electrical contact area 122 situated on each of the plurality of pliant portions 130. As shown in FIG. 1 for example, the electrical contact areas 122 may be disposed on a first side, such as the bottom side, of the pliant portions 130. According to some embodiments, the elastic biasing elements 132 may act upon a second side, such as the top side, of the pliant portions 130. In such a manner, for example, the elastic biasing elements 132 may be electrically isolated from the signal path while still being capable of maintaining the mechanical integrity of any connection between the first PCB 120 and the second PCB 140. According to some embodiments, the elastic biasing elements 132 and/or the electrical contact areas 122 may be associated with any or all sides and/or areas of the pliant portions 130. Both the elastic biasing elements 132 and the electrical contact areas 122 may, for example, be electrically isolated without requiring physical separation and/or isolation.

In some embodiments, the second PCB 140 may also or alternatively be a flexible PCB. The second PCB 140 may, for example, comprise pliant portions (not shown) similar to those of the first PCB 120. According to some embodiments, the second PCB 140 may comprise a plurality of electrical contact areas 142, each of which may include one or more electrical contact surfaces 146. As shown in FIG. 1 for example, the second PCB 140 may comprise a plurality of electrical traces 144 that terminate at a plurality of electrical contact surfaces 146. In some embodiments, the electrical contact surfaces 144 and/or the electrical traces 144 may be grouped in pairs to reduce common mode and/or differential discontinuities. Pairs of electrical traces 144 may, for example, carry differential and/or single-ended signals (e.g., a single-ended signal and a ground). In some embodiments, each electrical contact area 142 may comprise two electrical contact surfaces 146, one for each portion of a differential signal pair routed along the electrical traces 144.

According to some embodiments, the electrical contact areas 142 and/or the electrical contact surfaces 146 may be situated on the second PCB 140 such that when the first PCB 120 and the second PCB 140 are mated, the electrical contact areas 142 and/or the electrical contact surfaces 146 are electrically and/or mechanically coupled to the electrical contact areas 122 of the first PCB 120. Each pliant portion 130 may be acted upon by an elastic biasing element 132, for example, that compresses the electrical contact areas 122, 142 together to maintain the mechanical integrity of the substantially coplanar connection between the first PCB 120 and the second PCB 140. In some embodiments, the first PCB 120 and/or the second PCB 140 may comprise different quantities and/or configurations of electrical contact areas 122, 142 as may be appropriate, desired, and/or practicable.

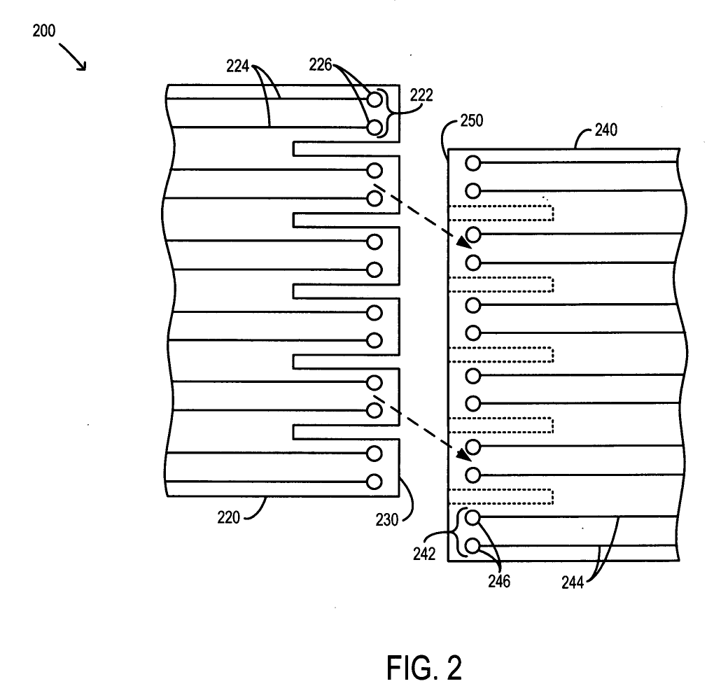

Referring now to FIG. 2, a plan view of a system 200 according to some embodiments is shown. In some embodiments, the system 200 may be similar to the system 100 as described in conjunction with FIG. 1. The system 200 may include, according to some embodiments, a first PCB 220 that may further comprise one or more electrical contact areas 222. In some embodiments, the first PCB 220 may also or alternatively comprise one or more electrical traces 224, one or more electrical contact surfaces 226, and/or one or more pliant portions 230. According to some embodiments, the system 200 may also or alternatively comprise a second PCB 240 that may further comprise one or more electrical contact areas 242, one or more electrical traces 244, and/or one or more electrical contact surfaces 246. In some embodiments, the second PCB 240 may also or alternatively comprise one or more pliant portions 250 (for which exemplary cutout lines are shown in phantom in FIG. 2). According to some embodiments, the components 220, 222, 230, 240, 242, 244, 246 of the system 200 may be similar in configuration and/or functionality to the similarly-named components described in conjunction with FIG. 1.

The system 200 may, according to some embodiments, be an electrical connector such as an electrical connector within and/or between electrical devices. One or more differential and/or multi-Gigabit per second signals may, for example, be desired to be transmitted from the first PCB 220 to the second PCB 240. In some embodiments, the first PCB 220 may comprise paired electrical traces 224 to route the signals to corresponding pairs of electrical contact surfaces 226 (e.g., located in electrical contact areas 222). According to some embodiments, each of a plurality of electrical trace 224 pairs may be routed along each of a plurality of pliant portions 230. Each pliant portion 230 may, for example, comprise one pair of electrical contact surfaces 226 to receive one or more differential, single-ended, and/or multi-Gigabit per second signals.

In some embodiments, fewer or more electrical traces 224 and/or pairs may be routed along each pliant portion 230. According to some embodiments, combinations of signals and/or signal pairs and/or various routing strategies may be employed as is or becomes desirable and/or practicable. Some pliant portions 230 may comprise two electrical traces 224, for example, while others may comprise one, two, three, or more electrical traces 224. The electrical traces 244 of the second PCB 240 may, according to some embodiments, be configured to mirror and/or otherwise correspond to the configuration of electrical traces 224 on the first PCB 220. In some embodiments, only some of the electrical contact areas 222 of the first PCB 220 may correspond and/or otherwise be associated with electrical contact areas 242 of the second PCB 240.

In some embodiments, the pliant portions 230 of the first PCB 220 may be biased toward the second PCB 240. One or more elastic biasing elements such as the elastic biasing elements 132 shown in FIG. 1 may, for example, be included in the system 200 to apply force (e.g., a normal and/or compressive force) to the pliant portions 230. The force applied to the pliant portions 230 may, according to some embodiments, cause the pliant portions 230 to deflect toward the second PCB 240 (and/or respective pliant portions 250 thereof). In the case that the first PCB 220 and the second PCB 240 are mated, the elastic biasing elements may, for example, compress the corresponding electrical contact surfaces 226, 246 to electrically and mechanically couple the first PCB 220 and the second PCB 240. In such a manner, for example, a substantially coplanar connection may be established between the corresponding pairs of electrical contact surfaces 226, 246.

According to some embodiments, the substantially coplanar connection may reduce and/or substantially reduce impedance discontinuities in the electrical traces 224, 244. The substantially coplanar connection may, for example, reduce, substantially reduce, and/or eliminate near-end reflections caused by impedance discontinuities, which may typically be confused with the actual signal received from the far end of the channel. Such high signal integrity in the electrical traces 224, 244 may, for example, allow Simultaneous Bi-Directional (SBD) signaling to be practicable at high bit rates. The high-bit rate SBD signaling may, according to some embodiments, be practicable in each direction of the electrical traces 224, 244 (e.g., for channel lengths encountered in PC chassis and/or within or between other electronic devices).

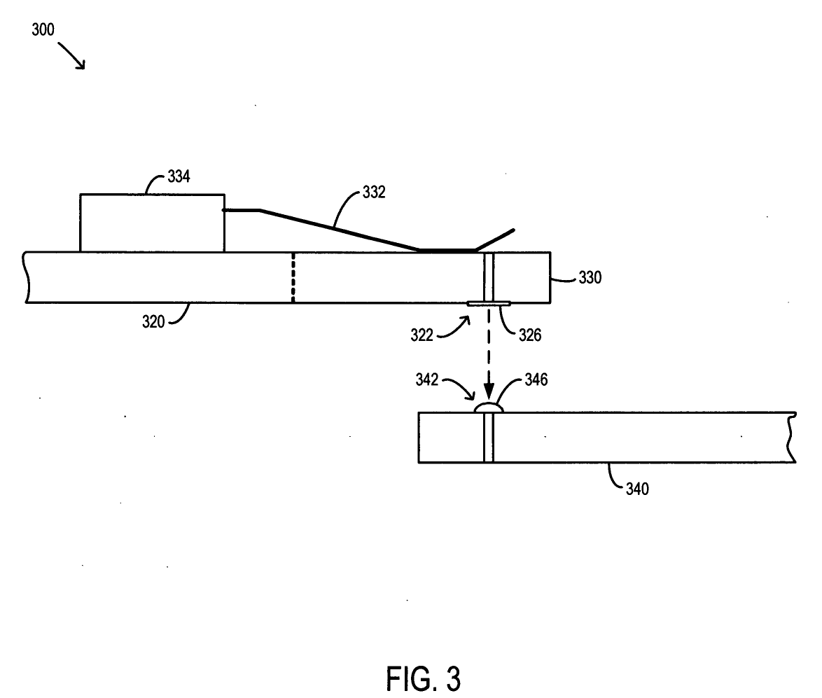

Turning to FIG. 3, a side view of a system 300 according to some embodiments is shown. In some embodiments, the system 300 may be similar to the systems 100, 200 described in conjunction with any of FIG. 1 and/or FIG. 2 herein. The system 300 may include, according to some embodiments, a first PCB 320 that may further comprise one or more electrical contact areas 322. In some embodiments, the first PCB 320 may also or alternatively comprise one or more electrical contact surfaces 326, one or more pliant portions 330, one or more elastic biasing elements 332, and/or a retaining mechanism 334. According to some embodiments, the system 300 may also or alternatively comprise a second PCB 340 that may further comprise one or more electrical contact areas 342 and/or one or more electrical contact surfaces 346. According to some embodiments, the components 320, 322, 330, 332, 334, 340, 342, 346 of the system 300 may be similar in configuration and/or functionality to the similarly-named components described in conjunction with any of FIG. 1 and/or FIG. 2.

In some embodiments, the first PCB 320 and/or the pliant portion 330 (and/or the second PCB 340) may comprise flexible PCB material. According to some embodiments, the pliant portion 330 may be more pliant than the first PCB 320. The pliant portion 330 may be defined by a slit, cut, and/or other discontinuity in the first PCB 320, for example, and/or may be biased by the elastic biasing element 332. In some embodiments, the elastic biasing element 332 may be a spring that is retained, at least partially, by the retaining mechanism 334 (e.g., a spring retainer). According to some embodiments, the elastic biasing element 332 may apply a force normal to the pliant portion 330. The force may, for example, cause the pliant portion 330 to be biased toward the second PCB 340 (e.g., substantially in the direction of the arrow shown in FIG. 3).

According to some embodiments, the force applied by the elastic biasing element 332 may provide mechanical integrity to the electrical connection between the first PCB 320 and the second PCB 340. The elastic biasing element 332 may, for example, force the electrical contact area 322 of the first PCB 320 against the electrical contact area 342 of the second PCB 340. In some embodiments, the electrical contact surface 326 of the first PCB 320 may be substantially centered on the electrical contact area 346 of the second PCB 340 and the two electrical contact surfaces 326, 346 may be mated at least in part due to the compressive force applied by the elastic biasing element 332. According to some embodiments, the electrical contact surface 326 of the first PCB 320 may be a wiping surface and/or the electrical contact surface 346 of the second PCB 340 may be a raised bump (such as a solder bump).

For example, although it is indicated by the arrow shown in FIG. 3 that the first PCB 320 and the second PCB 340 may be forced together normally (e.g., compressed by the elastic biasing element 332), other forces may also or alternatively be applied. In some embodiments for example, the first PCB 320 may slide laterally toward the second PCB 340. The pliant portion 330 may be forced to deflect upon contact with the second PCB 340 and/or with the electrical contact surface bump 346 (and/or due to other features, such as a connector housing, not shown in FIG. 3). In other words, the first PCB 320 and the second PCB 340 may be mated via a sliding action that includes lateral forces. In some embodiments, the lateral forces may cause and/or facilitate a wiping action between the electrical contact wiping surface 326 and the electrical contact surface bump 346. According to some embodiments, the wiping action may facilitate and/or cause the removal of deposits (e.g., corrosions, films, tarnishes, flux, and/or other contaminants) that form on either or both of the electrical contact wiping surface 326 and the electrical contact surface bump 346.

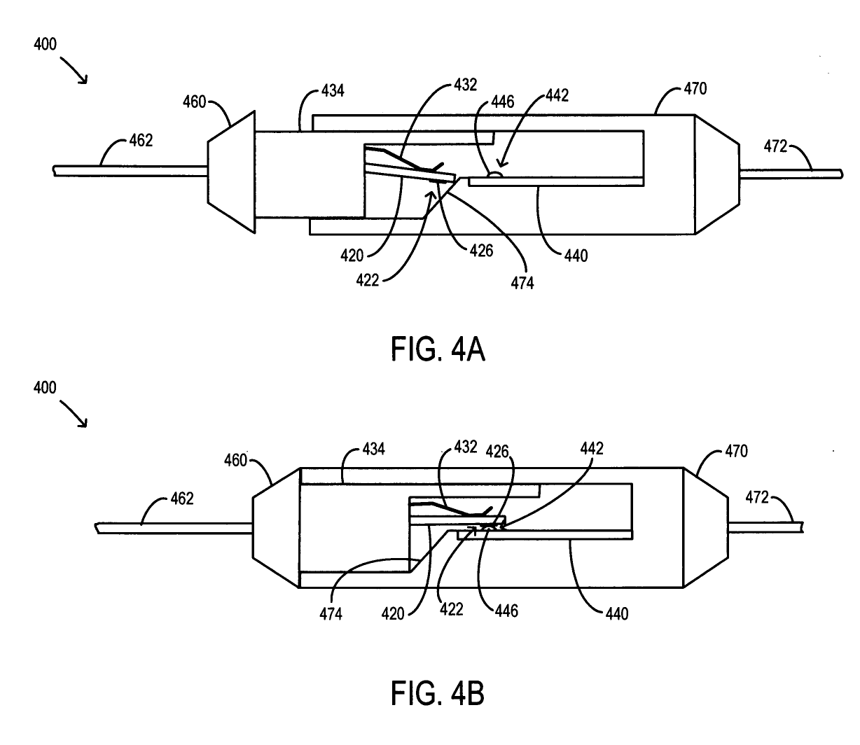

Referring now to FIG. 4A and FIG. 4B, cut-away side views of a system 400 according to some embodiments are shown. In some embodiments, the system 400 may be similar to the systems 100, 200, 300 described in conjunction with any of FIG. 1, FIG. 2, and/or FIG. 3 herein. The system 400 may include, according to some embodiments, a first PCB 420 that may further comprise one or more electrical contact areas 422. In some embodiments, the first PCB 420 may also or alternatively comprise one or more electrical contact and/or wiping surfaces 426, one or more elastic biasing elements 432, and/or a retaining mechanism 434. According to some embodiments, the system 400 may also or alternatively comprise a second PCB 440 that may further comprise one or more electrical contact areas 442 and/or one or more electrical contact and/or raised bump surfaces 446. In some embodiments, the system 400 may also or alternatively comprise a first connector body 460, a first signal channel 462, a second connector body 470, and/or a second signal channel 472. According to some embodiments, the components 420, 422, 432, 434, 440, 442, 446 of the system 400 may be similar in configuration and/or functionality to the similarly-named components described in conjunction with any of FIG. 1, FIG. 2, and/or FIG. 3.

In some embodiments, FIG. 4A may depict the system 400 in an un-mated state, while FIG. 4B may depict the system 400 in a mated state. In FIG. 4A, for example, the first and second connector bodies 460, 470 may be capable of being mechanically coupled. As shown in FIG. 4A and FIG. 4B, in some embodiments the first and second connector bodies 460, 470 may be configured as male and female connector halves, respectively. In other words, the first connector body 460 may be capable of being disposed within and/or partially within the second connector body 470. In some embodiments, the first and second connector bodies 460, 470 may also or alternatively be capable of being securely coupled. One or more portions of either or both of the first and second connector bodies 460, 470 may, for example, be configured to allow the connector bodies 460, 470 to be locked, joined, snapped together, and/or otherwise temporarily, removably, and/or permanently coupled.

The connector bodies 460, 470 described herein may be constructed, designed, and/or manufactured using any practicable materials that are or become available. The connector bodies 460, 470 may be fabricated, for example, of plastic, metal, and/or other composite materials and/or substances. In some embodiments, the connector bodies 460, 470 may be manufactured via injection molding, extrusion, casting, forging, stamping, and/or any combination thereof. According to some embodiments, the connector bodies 460, 470 may be milled, sanded, grinded, and/or otherwise constructed from a single piece of material. The connector bodies 460, 470 may, for example, by similar to connector bodies and/or components utilized in typical electrical connectors.

In some embodiments, the connector bodies 460, 470 may be configured to facilitate and/or otherwise promote the mating of the first PCB 420 with the second PCB 440. As shown in FIG. 4A and FIG. 4B, for example, the first PCB 420 may project from the first connector body 460 (and/or from the retaining mechanism 434). The first PCB 420 may, according to some embodiments, be deflected and/or displaced by the elastic biasing element 432. As shown in FIG. 4A, for example, the first PCB 420 may be deflected to such an extent as to cause the first PCB 420 to contact a portion of the second connector body 470 in the case that the first and second connector bodies 460, 470 are partially mated. The first PCB 420 may, in some embodiments, contact a sloped portion 474 within the second connector body 470.

According to some embodiments, upon further and/or complete mating of the connector bodies 460, 470, the first PCB 420 may be deflected by the sloped portion 474 such that the wiping surface 426 becomes positioned on the raised bump 446. In some embodiments, the sliding of the wiping surface 426 over the raised bump surface 446 may comprise a wiping action that removes deposits from one or both of the electrical contact surfaces 426, 446. According to some embodiments, because the first PCB 420 may be deflected by the second connector body 470 (and/or the sloped portion 474 thereof), the elastic biasing element 432 may compress the wiping surface 426 against the raised bump surface 446 (e.g., maintaining the mechanical integrity of the electrical connection).

In the case that the first PCB 420 is mated and/or coupled to the second PCB 440 (e.g., as shown in FIG. 4B), a substantially coplanar electrical connection may be formed. The first PCB 420 in the deflected mating position (e.g., caused by the second connector body 470, the sloped portion 474, and/or the raised bump surface 446) may, for example, be positioned substantially coplanar in relation to the second PCB 440. In some embodiments, an electrical signal (such as a differential signal pair and/or a multi-Gigabit per second signal) may be sent through the first signal channel 462 and into the first PCB 420. The electrical signal may then, for example, proceed substantially perpendicularly to the coplanar PCB segments 420, 440 and into the second PCB 440. According to some embodiments, the signal may then proceed through the second PCB 440 and into the second signal channel 472. In such a manner, for example, a multi-Gigabit per second signal may be transmitted through the system 400 while maintaining the signal integrity required for transmission of such signals.

In some embodiments, the second PCB 440 may be fixed and/or substantially fixed to the second connector body 470 as shown in FIG. 4B. According to some embodiments, the second PCB 440 may be a flexible PCB and/or may be acted upon by an elastic biasing element (not shown) similar to the elastic biasing element 432. The second PCB 440 may, for example, be configured similar to the first PCB 420. In some embodiments, for example, the second PCB 440 may also or alternatively be biased toward the first PCB 420 to facilitate the coupling and/or mating of the PCB elements 420, 440. According to some embodiments, either or both of the connector bodies 460, 470 may be configured differently than shown in FIG. 4A and FIG. 4B. The connector bodies 460, 470 may, for example, be integrated into a single coupling that is configured to receive both the first PCB 420 and the second PCB 440 (e.g., a single connector body 460, 470 that is configured to mate two male or two female PCB elements 420, 440).

In some embodiments, the signal channels 462, 472 may be or include the respective PCB elements 420, 440. The first signal channel 462 may, for example, be a portion of the first PCB 420 (e.g., a portion that protrudes from the end of the first connector body 460 opposite the deflected portion of the first PCB 420). According to some embodiments, either or both of the signal channels 462, 472 may be an electrical trace, wire, cable, and/or other signal path. The second signal channel 472 may, for example, be an electrical trace within a portion of the second PCB 440 that is continuous with the portion of the second PCB 440 disposed within the second connector body 470.

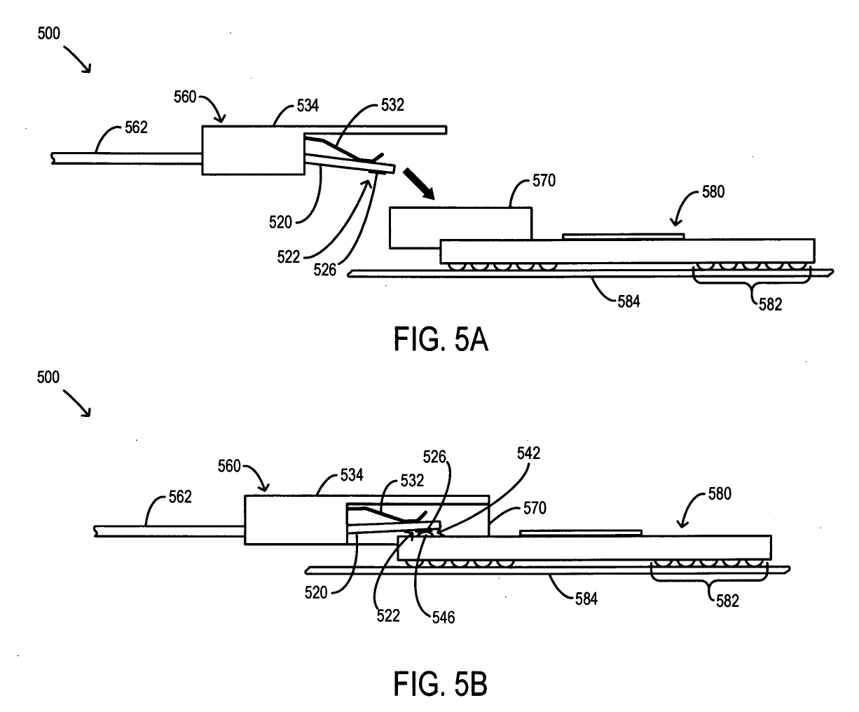

Turning now to FIG. 5A and FIG. 5B, a side view and a cut-away side view, respectively, of a system 500 according to some embodiments are shown. In some embodiments, the system 500 may be similar to the systems 100, 200, 300, 400 described in conjunction with any of FIG. 1, FIG. 2, FIG. 3, and/or FIG. 4 herein. The system 500 may include, according to some embodiments, a first PCB 520 that may further comprise one or more first electrical contact areas 522. In some embodiments, the first PCB 520 may also or alternatively comprise one or more first electrical contact surfaces 526, one or more elastic biasing elements 532, and/or a retaining mechanism 534.

According to some embodiments, the system 500 may also or alternatively comprise one or more second electrical contact areas 542 and/or one or more second electrical contact surfaces 546. In some embodiments, the system 500 may also or alternatively comprise a first connector body 560, a first signal channel 562, a second connector body 570, and/or a second signal channel 572. In some embodiments, the second electrical contact area 542 and/or the second electrical contact surface 546 may be disposed within and/or on an IC package 180. The IC package 580 may, for example, be connected via one or more sockets 582 to a motherboard 584. According to some embodiments, the components 520, 522, 532, 534, 542, 546, 560, 562, 570, 572 of the system 500 may be similar in configuration and/or functionality to the similarly-named components described in conjunction with any of FIG. 1, FIG. 2, FIG. 3, and/or FIG. 4.

In some embodiments, the first connector body 560 may couple to the second connector body 570 to mate and/or electrically couple the first PCB 520 to the IC package 580. An electrical signal may, for example, be sent via the first signal channel 562 to the first PCB 520, and may be desired to be transmitted to the IC package 580. According to some embodiments, the signal may originate from a memory device (not shown in FIG. SA or FIG. 5B) and/or other electrical component. In some embodiments, it may be desirable to send a signal from the IC package 580 to the first PCB 520, and via the first signal channel 562 to another electrical component (e.g., a memory device, another IC package, a display device, and/or a peripheral device).

As shown in FIG. 5B, the first connector body 560 may be coupled to the second connector body 570, causing a deflection of the first PCB 520. The deflection of the first PCB 520 may, for example, cause the elastic biasing element 532 to exert a substantially normal force upon the first PCB 520. In some embodiments, the force may allow the electrical connection between the first electrical contact surface 526 and the second electrical contact surface 546 to be mechanically maintained. In other words, the elastic biasing element 532 may apply a compressive force that substantially prevents the decoupling of the first electrical contact surface 526 and the second electrical contact surface 546. According to some embodiments, the mating and/or coupling of the first electrical contact surface 526 and the second electrical contact surface 546 may form a substantially coplanar connection between the first PCB 520 and the IC package 580.

In some embodiments, the second connector body 570 may be disposed on the upper surface and/or top layer of the IC package 580. The signal transmitted via the substantially coplanar connection between the first PCB 520 and the IC package 580 may, for example, not be required to pass through other layers of the IC package 580. Accordingly, the IC package 580 may not be required to propagate high-speed, high-bandwidth, and/or other signals transmitted via the first PCB 520 through the IC package 580 and/or through the socket 582 that connects the IC package 580 to the motherboard 584. In such a manner, for example, the cost of manufacturing the IC package 580 may be reduced.

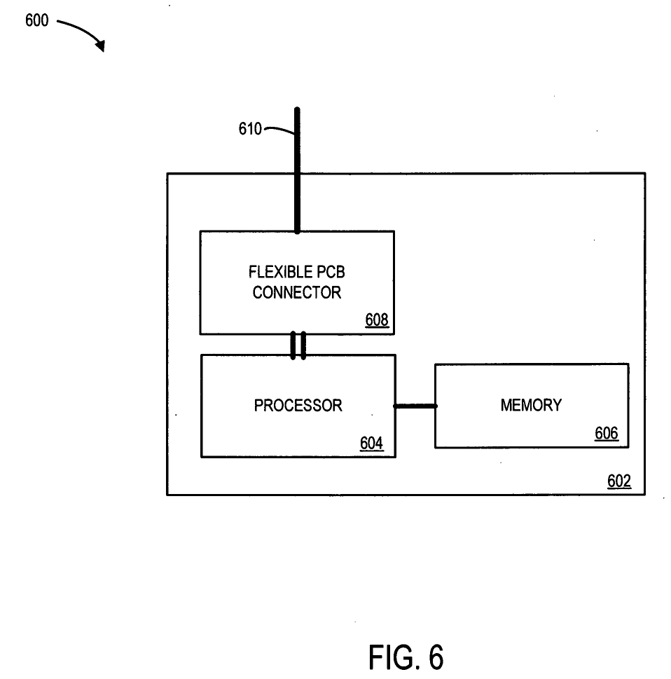

Referring now to FIG. 6, a block diagram of a system 600 according to some embodiments is shown. The system 600 may include, for example, a motherboard 602, a processor 604, a memory 606, a flexible PCB connector 608, and/or a signal channel 610. In some embodiments, the processor 604 may be in communication with the signal channel 610 via the flexible PCB connector 608. The flexible PCB connector 608 may, for example, be or include a connector such as is described conjunction with FIG. 5A and FIG. 5B herein. According to some embodiments, the flexible PCB connector 608 may include one or more connector bodies (such as the connector bodies 560, 570) that may include one or more portions that are mechanically coupled to the processor 604 and/or to the motherboard 602. According to some embodiments, the components 602, 604, 606, 608, 610 of the system 600 may be similar in configuration and/or functionality to the similarly-named components described in conjunction with any of FIG. 1, FIG. 2, FIG. 3, FIG. 4, and/or FIG. 5.

The processor 604 may be or include any number of processors, which may be include any type or configuration of processor, microprocessor, and/or micro-engine that is or becomes known or available. The memory 606 may be or include, according to some embodiments, one or more magnetic storage devices, such as hard disks, one or more optical storage devices, and/or solid state storage. The memory 606 may store, for example, applications, programs, procedures, and/or modules that store instructions to be executed by the processor 604. The memory 606 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

The flexible PCB connector 608 may be any type and/or configuration of flexible PCB connector that operates and/or is configured in accordance with embodiments described herein. In some embodiments, the flexible PCB connector 608 may comprise one or more electrical contact areas disposed upon a flexible PCB material. According to some embodiments, at least one portion of the flexible PCB material (e.g., a portion comprising one or more of the electrical contact areas) may be biased and/or deflected by one or more elastic biasing elements. In some embodiments, the flexible PCB connector 608 may also or alternatively comprise one or more electrical contact areas situated on one or more pliant portions. The pliant portions may, for example, be finger-like portions of the flexible PCB material that are mechanically and/or electrically isolated from each other. According to some embodiments, the flexible PCB connector 608 may otherwise be configured in accordance with embodiments described herein.

The flexible PCB connector 608 may, for example, form a substantially coplanar connection with the processor 604. In some embodiments, the substantially coplanar connection may facilitate and/or allow multi-Gigabit per second signals to be transmitted to and/or from the processor 604 (e.g., via the signal channel 610). The substantially coplanar connection may, for example, reduce and/or eliminate impedance discontinuities that may otherwise limit and/or prevent the transmission of high-speed and/or high-bandwidth signals.

In some embodiments, the flexible PCB connector 608 may pass multi-Gigabit per second signals to and/or from the processor 604. The flexible PCB connector 608 may, for example, have a resonance cutoff that is substantially greater than typical connectors. The bandwidth of a connector may typically not exceed the resonance of the connector, which, for example, is typically a function of the connector's mechanical dimensions (e.g., mated pin length). Typical connectors that require and/or utilize pins and sockets generally have mated pin-lengths in the one half (0.5) to two (2) centimeter (cm) range, which yields a resonance cutoff in the two (2) to five (5) GHz range.

According to some embodiments, the discontinuity of the flexible PCB connector 608 may be associated with the dimensions of the mating surfaces (e.g., the electrical contact areas 122, 142, 222, 242, 322, 342, 422, 442, 522, 542 and/or electrical contact surfaces 146, 226, 246, 326, 346, 426, 446, 526, 546). The mating surfaces may, for example, be in the one (1) millimeter (mm) size range, yielding potential resonant frequencies in excess of twenty-five (25) GHZ. In such a manner, for example, the flexible PCB connector 608 may be capable of transmitting signals substantially five (or more) times faster than typical connectors.

The several embodiments described herein are solely for the purpose of illustration. Other embodiments may be practiced with modifications and alterations limited only by the claims.

1. An electrical connector, comprising:
a first flexible printed circuit board comprising a first pliant portion and a second pliant portion,
the first pliant portion including a first electrical trace and a second electrical trace of a first differential signal pair, the first electrical trace including a first electrical contact surface, and the second electrical trace including a second electrical contact surface, and
the second pliant portion including a third electrical trace and a fourth electrical trace of a second differential signal pair, the third electrical trace including a third electrical contact surface, and the fourth electrical trace including a fourth electrical contact surface; and
an elastic biasing element to bias at least one of the first pliant portion and the second pliant portion in at least one direction.

2. (canceled)

3. The electrical connector of claim 1, wherein the first pliant portion and the second pliant portion are substantially more pliant than other portions of the first flexible printed circuit board.

4. (canceled)

5. (canceled)

6. The electrical connector of claim 1, further comprising:
a second printed circuit board, comprising a fifth electrical trace and a sixth electrical trace of the first differential signal pair the fifth electrical trace comprising a fifth electrical contact surface, and the six electrical trace comprising a sixth electrical contact surface,
wherein the elastic biasing element is to bias the first electrical contact surface and the second electrical contact surface toward the fifth electrical contact surface and the sixth electrical contact surface respectively.

7. The electrical connector of claim 6, wherein a substantially coplanar electrical connection is formed by mating the first electrical contact surface and the second electrical contact surface with the fifth electrical contact surface and the sixth electrical contact surface, respectively, using a sliding action.

8. The electrical connector of claim 6, wherein the second printed circuit board is a flexible printed circuit board.

9. The electrical connector of claim 6, wherein the second circuit board further comprises a third pliant portion including the fifth electrical contact surface and the sixth electrical contact surface.

10. The electrical connector of claim 9, wherein the second circuit board further comprises a fourth pliant portion including a seventh electrical trace and an eighth electrical trace of the second differential signal pair, the seventh electrical trace of the second differential signal pair comprising a seventh electrical contact surface, and the eighth electrical trace of the second differential signal pair comprising an eighth electrical contact surface.

11. The electrical connector of claim 10, further comprising:
a second elastic biasing element to bias the second electrical contact surface and the third electrical contact surface toward the seventh electrical contact surface and the eighth electrical contact surface, respectively.

12. The electrical connector of claim 1, wherein the elastic biasing element comprises a spring.

13-28. (canceled)
